(19) United States
(12) Patent Application Publication
(10) Pub. No.: US 2005/0246191 A1
(43) Pub. Date: Nov. 3, 2005

(54) Method of sample distribution, sample tracking and integration with sales follow-up

(75) Inventor: Heinz-Guenter Lux, Rye Brook, NY (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 11/047,563

(22) Filed: Feb. 2, 2005

Related U.S. Application Data
(63) Continuation of application No. 10/833,071, filed on Apr. 28, 2004, now abandoned.

(51) Int. Cl. G06F 17/60

(52) U.S. Cl. 705/1; 705/15

(57) ABSTRACT

A process for coordinating sample requests includes receiving a sample order over a computer based network such as the Internet, vetting the sample order to determine whether or not the intensions of the sample applicant are bona fide, permitting any bona fide sample applicant to access both an automated sample order system and a technical database. Samples may be provided to the bona fide sample applicant through an automated shipping routine. After receipt and use of the sample the sample applicant may be contacted for information regarding the performance of the sample. The sample applicants information requests and sample orders are archived in libraries accessible by the sample applicant for future reference.

### BACKGROUND OF THE INVENTION

### FIELD OF THE INVENTION

The invention relates to a process that may include vetting an applicant for a sample, providing the sample applicant access to a sample ordering function and access to a library database of technical information while concurrently notifying a sales representative for commercial follow-up of sample requests by transferring the sample applicant's identity and sample requests to the sales representative. The invention further relates to a process that includes archiving a sample applicant's sample request information and technical database retrievals to form an applicant sample database and an applicant information database which may be accessed later as needed by the sample applicant.

### DESCRIPTION OF THE BACKGROUND

In many commercial endeavors it is desirable to provide potential new customers (e.g., sales prospects) with a sample of the product for which purchasing negotiations are underway or may be undertaken in the future. The person requesting a sample is a sample applicant and may be an individual or an entity that may be a potential new customer or otherwise have an ongoing commercial or contractual relationship with another party. In many businesses the provision of samples to potential new customers is a requisite part of a functional marketing process. In some industries samples are made available to any sample applicant without any pre-approval phase other than obtaining a shipping address. Such industries may be characterized by a commodity atmosphere wherein the value in the commercial good is not based upon technological characteristics of the commercial good but upon the supplier's ability to provide the commercial good at an advantageous price, in a certain quantity, at a certain location or other marketing characteristic. In such industries there is little need to pre-screen (e.g., pre-approve or vet) sample applicants to determine whether or not their sample request is bona fide because it is unlikely the sample applicant will try to copy or reverse engineer the sample since equivalent substitutes may be readily available through other sources or suppliers.

In industries and businesses where samples inherently provide access to important technological details such as the composition of the sample or the process by which the sample is manufactured, it may be beneficial for a sample supplier to vet a sample applicant in order to determine that the sample applicant is a bona fide potential new customer whose intentions are to test the sample material for its commercial advantages and not to undertake a forensic or reverse engineering analysis of the sample. Therefore it is desirable to restrict the distribution of technologically sophisticated samples to only those sample applicants who are bona fide potential new purchasing customers and specifically exclude sample applicants whose intentions may be to copy or otherwise develop an equivalent substitute.

In some industries the number of sample applicants can be very large and therefore the screening process can be complicated and time consuming. Traditionally, in the case where a sample applicant requests a sample from which secret information may be derived but which the sample supplier wishes to remain secret, the sample applicant would first directly contact a sales representative of the sample supplier to request a sample. The sales representative would then have a face-to-face meeting with the sample applicant to determine whether or not the sample applicant's request was bona fide and to help identify the most appropriate sample for the sample applicant's needs.

The traditional approach of sampling may require multiple visits or contacts between the sample applicant and a sales representative of the sample supplier. Each contact between the sample applicant and the supplier's sales representative may be very expensive depending on the distance between the supplier's sales representative and the applicant, and the degree to which the sample applicant wishes to be entertained. If the sales representative must travel a significant distance a sales visit may cost several thousand dollars.

After a good relationship has been established between the sample supplier's sales representative and the potential new customer, the visits between the sales representative and the sample applicant may decrease. However, the sample applicant may have continuing questions and may wish to have access to or be provided with technical information and supporting literature for the sample. Thus the sample applicant must contact another group or individual employed by the sample supplier to request the desired information. Accessing the literature may take time if the marketing department of the sample supplier cannot efficiently and quickly locate the desired information. In the meantime, the sample applicant may be waiting to perform tests and experiments. Waiting for information may result in substantial delays between the sample applicant's conceptualization of a new idea for a new product, the receipt of a sample, the receipt of supporting information or literature, and the eventual conclusion of the tests by the sample applicant.

Traditional sampling and sales follow-up methods rely on a system in which the sales representative has the greatest incentive to respond most quickly and devote the most resources to established customers. There may be less incentive for a sales representative to initiate and follow-up with smaller potential new customers who may be viewed by the sales representative as not providing the opportunities for income associated with a larger existing customer. Consequently, it may happen that smaller customers and/or new business prospects are not provided with the care and attention such as follow-up on sample requests that is necessary in order to develop a good business relationship.

This dilemma is further complicated where the sample may be a material having hazardous properties. Especially in the chemical industry where shipping, transport and disposal of materials may be expensive and dangerous, the process of providing potential new customers with samples can be even more expensive and time consuming.

It is preferred by some sample applicants that new samples be received and evaluated as quickly as possible. Reducing the cycle time associated with taking a research and development concept from its initial stages to preparing a commercially viable product are preferred to be as low as possible. In order to meet any product-to-market time tables set by the marketing organization of the sample applicant, samples must be made available and evaluated quickly and efficiently by the sample applicant. Delays associated with ordering samples may significantly and negatively affect the sample applicant's ability to maintain a desired schedule. It may be possible for the sample supplier to achieve a strategic advantage over competitors by providing a sample ordering system which quickly and efficiently provides samples to sample applicants. Once a sample applicant becomes familiar with the sample ordering process of a sample supplier and begins to rely almost exclusively on the sample ordering system of a preferred sample supplier, a strategic advantage may be realized by the sample supplier.

Industries having significant technological sophistication, such as the chemical industry, typically provide a great deal of supporting information to potential customers. In many cases this technical literature is supplied directly with a sample. If this literature is separated from the sample upon receipt of the sample by the sample applicant it may be difficult for the sample applicant to easily obtain a replacement. If the technical literature is available only as a hard copy, the sample applicant must request a copy of the sample literature either directly through the marketing arm of the sample supplier or through a local sales representative.

It is desirable to allow a sample applicant access to as much technical information as the sample applicant may need in order to fully test a sample and complete product and/or marketing trials. The availability of supporting information may be essential to the sample applicant's ability to successfully carry out experiments and new product trials. The technical information available from a sample supplier is usually the result of significant amounts of time and resources devoted by the sample supplier and represents a real and quantifiable expenditure by the sample supplier.

Technical information made available to customers and sample applicants may not qualify for trade secret protection. It is nevertheless to the advantage of the sample supplier to be able to restrict and control the distribution and dissemination of this information to only those parties (e.g., sample applicants) who represent actual and bona fide new sales prospects. Competitors, such as smaller companies who are unable to afford the technical development necessary for supporting such technical information may benefit at the expense of the sample supplier if they have free access to such information from a competing supplier. Others, such as consultants and foreign governments, may wish to achieve personal or commercial gain from the access of this technical information at the expensive of the sample supplier who originally developed the information.

Since samples may contain hazardous materials it is imperative that they are tracked continuously through the shipping process and their receipt at the sample applicant is verified. If a sample is damaged during shipment and is found to leak, for example, its disposal and handling may be very expensive and may even require the evacuation of an area if the sample material enters the environment. It is important that the sample supplier be able to track the location of the sample at all times and provide advice to any emergency service personnel or disposal team if a leak or other sample damage occurs. Such support must be available on an uninterrupted basis 24 hours every day of the year.

It has been common practice in analytical laboratories and research and development departments to collect samples over time. Although a sample of moderate size may be received (e.g., 1 kg or less) only a small amount (on the order of grams) of the sample material may actually be used. Typically, the excess sample material is stored in a sample storage area. The samples may not be immediately disposed of because the costs of disposal can be high. However, the consequence of receiving many samples over a period of time results in a large sample inventory that must eventually be discarded.

If a sample is not provided with an expiration date, the sample applicant may mistakenly believe that a particular material is still in condition for experimental use and may not know that the sample is outdated. The consequence may be that the outdated sample provides inferior results and the sample applicant is left with the impression that the sample provided by that particular supplier is not acceptable for the sample applicant's use. This may be avoided if the sample is provided with a date of expiration.

The organizational structures of some potential new customers are large and several research groups within a single organization may be working on related projects but have little or no knowledge of one another's related efforts. This may cause duplication of sampling requests to a single organization when only a single sample would be sufficient. Minimizing such duplication is one way to reduce sampling costs and increase project efficiency at the sample applicant.

Placing orders over a computer network such as the Internet is known. The Internet however is characterized by its anonymity and many users of this computer network are hesitant to provide personal information to allow a sample supplier to follow-up on a sample request.

The Internet and other computer based networks have proven to be an effective and efficient method for disseminating information and taking orders from customers. One of the perceived benefits of the Internet to on-line purchasers of goods and/or individuals wishing to access certain information, is the relative anonymity afforded by such computer-based systems. This anonymity is contradictory to the desire of sample suppliers who market materials having technological value to maintain control and limit access to technological know-how. While on the one hand a sample supplier may benefit greatly through the efficiencies gained by on-line sample ordering and information availability, the supplier may be harmed by the undesired dissemination of information and samples to sample applicants whose intentions with the sample or technical information are not in line with the sample supplier's business interests.

It may be possible to achieve substantial efficiencies in the process for ordering samples and obtaining technical information if the process is automated over a computer based network. Any such automation must, however, not come at a cost of loss of confidentiality. The automated process must also provide a way for sample orders to be tracked during shipping and transport and must further provide a structure by which the original sample order may be followed up to receive the sample applicants' feedback.

### SUMMARY OF THE INVENTION

Accordingly, it is one object of the invention to provide a process for allowing sample materials to be ordered over a computer based network by sample applicants who have been vetted or who are vetted concurrently with order placement while allowing bona fide sample applicants access to technical information and then to follow-up the sample order to determine the suitability of the sample for the sample applicant.

It is a further object of this invention to form a technical information database and a sample request database by archiving sample requests and information requests and relating the requests to the organization/entity from which the sample or information requests originated then permitting access to the databases to anyone who is positively identified as originating from the organization.

It is another object of this invention to create a database of bona fide sample applicants.

It is another object of the invention to track the progress of a sample order from placement of the order through shipping and receipt.

It is another object of the invention to provide a personalized library of technical information organized by the identity of the employer or organization with which the sample applicant is associated and to restrict access to the personalized library to only vetted sample applicants.

It is a further object of this invention to notify a sample supplier sales representative of the placement of a sample order and identity of the sample applicant.

It is another object of this invention to track sample requests and develop therefrom marketing and research strategies to solve application issues associated with clusters of sample requests.

It is another object of the invention to accumulate sample applicant data and therefrom determine the cost of sampling to the organization with which the sample applicant is associated.

It is another object of the invention to collect and archive comments and feedback from the sample applicant regarding the performance and suitability of the requested sample.

It is a further object of the invention to provide a process for reducing the sample tracking and sample distribution cost for a sample supplier while concurrently reducing sample disposal, sample storage and sample tracking information by a sample applicant.

It is a further object of the invention to organize sample applicants by communities defined by a common business interest or organizational structures and create technical libraries and sample inventory databases accessible to members of the communities.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows the environment of bona fide sample applicants and the interaction between a sample supplier and bona fide applicant in comparison to the blocked transfer of materials and information between an applicant who is not bona fide and the supplier.

FIG. 2 is a description of some of the components of the computer-based network.

FIG. 3 is a flow chart showing some of the actions of a process for ordering, tracking, and follow-up of a sample order.

FIG. 4 shows the relationship between individual sample applicants, the organization by which they are employed or which they represent, and technical sub-libraries containing information previously made available to the organization.

FIG. 5 is a flow chart of follow-up actions and the division or group within a sample supplier organization responsible for carrying out follow-up.

FIG. 6 is a flow chart of a vetting process.

FIG. 7 shows the interrelationship of the sample applicant and sample supplier.

FIG. 8 is a schematic illustration of a computer system that may function as a point of entry to access and make use of a process including ordering samples and accessing technical information over a computer-based network.

### DETAILED DESCRIPTION OF THE SPECIFIC EMBODIMENTS

The invention includes a process that provides integration of sample ordering, vetting of sample requests, sample tracking, technical information access, sales and distribution, technical information access, and new product development through an automated computer-based network.

The term “bona fide” is used herein to describe a sample request or an information request submitted by a party having or intending to form a mutually beneficial commercial relationship with the sample supplier. Parties submitting a of a bona fide request for a sample or for technical information fide includes those parties who attempt to access the sample supplier's technical know-how with no intention of forming a mutually beneficial commercial relationship for both the requester and the sample supplier. The term “sample applicant” is used herein to identify an individual or organization (e.g., corporation) which wishes to obtain a sample. The term “sample supplier” is used herein to identify the organization or individual (e.g., corporation) which offers and manufactures the material to be sampled to a sample applicant.

The term “vetting” is used herein to indicate that information from a sample applicant is analyzed, for example in comparison to a database of information or by logic, to determine whether or not a sample applicant may be given the privilege to place and/or access sample orders or have access to certain technical information.

Certain characteristics may be associated with any of the parties or business organizations that are integrated into the process through a database or library. Customers (e.g., sample applicants) are integrated into the process in a manner that allows for automated sample ordering and access to a technical library through a system which allows a sample supplier to vet a customer before allowing the customer or sales prospect to participate in the process. The sales and distribution function of a sample supplier organization is involved by providing criteria by which customers and new sales prospects may be identified and vetted before they are permitted access to the process. Marketing is integrated with sales and distribution in a manner which permits continuous improvement of product lines by collecting and associating certain products and sampling trends, new research and development and other efforts intended to address issues identified through feedback from the sampling program. Marketing is further involved in the process by integrating a hierarchy and organization of sales representatives, distributors and other interested parties to provide for follow-up on samples shipped to potential new customers. Marketing is further involved by integrating with other parties such as outside vendors who provide services which may benefit the process, for example, logistics services. Each of these functions is connected through a library which contains not only the technical library which may be of interest to the customer or potential new sales prospect, but also contains a database and archive of sample information.

In a preferred embodiment a sample applicant accesses the sample ordering function and initiates the process through an electronic interface to the sample supplier. The electronic interface is preferably via a website identified by a unique record locator (URL).

One embodiment the invention process includes a sample applicant initiating a sample order or a request for technical information over a computer-based network; vetting the sample applicant by information provided in the sample applicant's request; assigning a bona fide or not bona fide status to the sample applicant's request; allowing bona fide sample and/or information requests to be fulfilled; packaging, shipping and tracking the delivery of a sample to the sample applicant; following up with the sample applicant to determine the status of the sample's performance through a sales representative, distributor or marketing organization representative by directly contacting the sample applicant; determining through feedback provided by sample applicant and statistical information derived from the number of sample requests and other information new research and development topics for improved products; and creating personalized libraries to include technical information and sample information of materials and information previously requested by any sample applicant belonging to a specific organization or community.

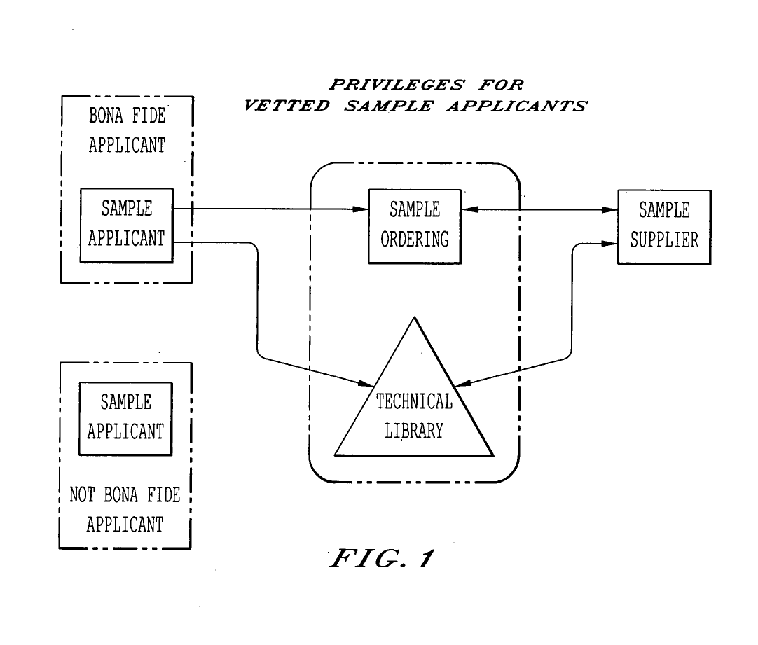

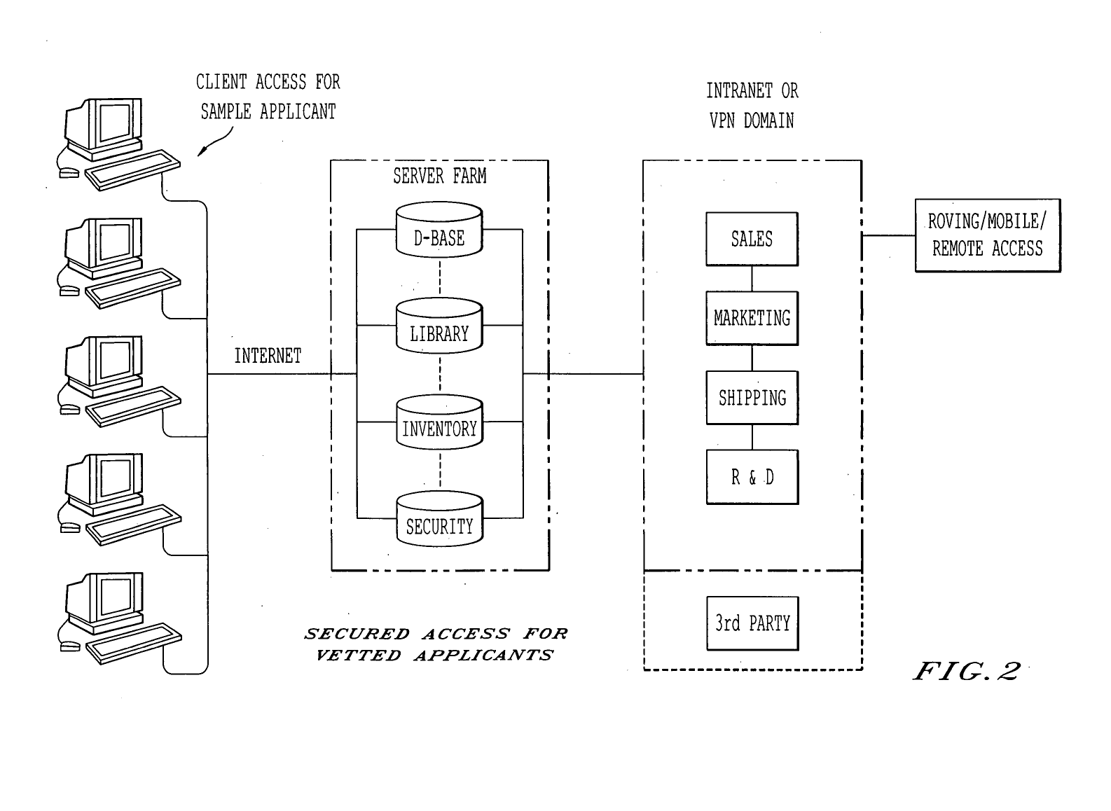

FIG. 1 shows how a sample applicant vetted as bona fide is able to access the sample ordering and technical library function of the process. A bona fide sample applicant may access one or both of the sample ordering and technical library functions over a computer based network. A sample applicant who is not bona fide is blocked from at least the sample ordering and technical library functions. The non-bona fide sample applicant may still access the sample supplier's website to access general information but may not access the special functions of the process.

The process of vetting a sample applicant and determining the applicants' status and/or intention may be automated and may take place over a computer-based network. A computer-based network may include the Internet (world wide web), electronic data interchange (EDI) between two or more parties, shared access to server farms or stored databases, a virtual private network (VPN), an intranet and other means by which information is communicated electronically or by fiber optic media in a digital format. The Internet is the preferred computer based network and may be used as a means for inputting a sample order, transferring data between a sample applicant and a sample supplier, accessing a technical library, providing communication between, for example, a sales force representative, and a division or department within a commercial organization.

Typically, a computer-based network connects a multitude of individual user terminals. The activities and data transfer occurring in the computer-based network are controlled and trafficked through, for example, a router which ensures complete delivery of an entire message to the correct recipient.

FIG. 2 provides an example of a computer-based network and the connections between a sample applicant and a sample supplier. One or more sample applicants may be connected through the computer-based network through client terminals. Client terminals include Internet appliances, conventional workstations and personal computers that may contain a CPU (central processing unit) and conventional memory devices. More than one client may access the computer based network at a time. Clients from different organizations may independently access the computer-based network without compromising the security or confidentiality of the other party's access. The client may access the computer-based network through a conventional hard line such as telecommunication infrastructure (e.g., copper lines) or through a wireless connection. Any means of connecting the client to the computer-based network may be used. The computer-based network provides a connection between the client of the sample applicant and the database and functionality of the process. The sample supplier may execute the functionality of the process on a server or other central processing unit which may include other conventional communications hardware. The function and database architecture of the process may be contained on a single server or may be provided on a series of interconnected servers. In a preferred embodiment all of the functionality including each database, library, inventory and functionalities including security screening and routing are included and executed by a single server. The server functionality may also be accessed by the sample supplier. The sample supplier may be interconnected to the server through the Internet, an intranet, virtual private network or other direct or indirect connection to the server and functionalities. The sample supplier may access the server through the Internet. The sample supplier may also access the server through a remote client that may connect either directly to the server through a computer-based network or may first access an intranet or VPN from which further access is provided to the server and the functionalities therein. Any organizational function of the sample supplier may access the server functionalities and the information provided therein. Therefore any of the sales, marketing, shipping or research and development organizational units of the sample supplier may access the information such as the personal technical libraries or sample inventory libraries for any sample applicant. A third party may also access specific information provided either on the server or otherwise in the sample supplier's Internet or VPN. The third party typically has only restricted access to certain information which may be useful for carrying out the responsibilities of the third party, such as shipping.

A sample applicant may be vetted in a number of ways. Applicant vetting may be carried out, for example, by comparing the electronic mail (e.g., e-mail) address of the sample applicant with a database of e-mail addresses. In some cases an e-mail address carries within it information regarding the organization or entity (e.g., community) with which a sample applicant is associated. Many e-mail protocols include the employer name within the e-mail structure. For example, an e-mail address may take the form “John.Smith@company.com.” In this case, the “company” directly corresponds to the employer or organization with which the sample applicant is associated. If the company has been identified as having not bona fide intentions the request can be readily identified as not bona fide and treated appropriately. In addition to the e-mail address the shipping information entered upon initiation of a sample request may be compared with a database of samples. If the physical shipping address corresponds with a physical address known to represent a not bona fide sample applicant, shipment may be denied.

Use of the Internet provides a medium which allows interface between different software platforms. Typically a TCP-IP method of communication is employed. This protocol allows data to be transferred rapidly and efficiently between networks even when those networks utilize different software systems. The Internet provides a communication medium and graphical user interface (GUI) that is well recognized and for which interface tools are readily available to many users and requires little or no training for most users.

It is preferred that the information associated with the invention process, such as a database of approved and bona fide sample applicants and a technical library, for example, are maintained through the same application server and server software used for other aspects of the invention process. A single software platform provides easier maintenance and may be more readily customized to interface with other software systems used on an organization- or community-wide basis at the sample supplier. Since the software system used as a platform to aid in carrying out the invention process must communicate over the Internet, the protocol for communicating with other software systems may already be in place and thereby facilitate communication and integration with the software systems used by other organizations, such as a third party logistics supplier, or the software systems used by the sample applicants.

In one aspect, the process allows a sample applicant to input an order for a specific sample material. The sample applicant is vetted beforehand by an analysis of information that the sample applicant inputted immediately previously or on another occasion or during another Internet session. For example, a sample applicant requesting a particular material must necessarily enter a shipping address in order to receive sample material. The shipping address entered by the sample applicant may automatically be compared against a database of shipping addresses. The database of shipping addresses may be one which the sample supplier has individually assembled or may be a database of shipping addresses that is purchased from a third party. The database of shipping addresses may be updated constantly so that information from new sample applicants is stored and associated with each specific sample applicant. The comparison may identify addresses of not bona fide sample applicants. For example, comparison of the inputted address may match the address of the physical location of a competitor or another party known to be adverse to the sample supplier. The comparison is conducted electronically and does not require intervention by a person. When a non-bona fide sample applicant is identified, the process may respond, for example, by immediately sending a message to the e-mail address of the sample applicant informing the sample applicant that direct contact with a sales representative must be initiated before a sample can be made available. The process may also respond by simply accepting the information and not sending a sample or message.

A sample applicant wishing to place a sample order may first access general product information provided openly and publicly to many or all users without restriction, for example on the Internet website. After identifying a general class or family of materials the sample applicant may request further information to narrow the search for the appropriate sample material. The process may provide multiple levels of access and security. In a first level, all users may access the general information provided over the computer based network. The information may include general and/or generic product descriptions that may encompass a broad product line or multiple product lines. Specific performance properties, physical characteristics, and analytic results may not be available on the first level of information access since no inputted data is yet available for vetting.

Upon identifying the general product class the sample applicant may desire more information which can be accessed through an HTML (hyper-text mark-up language) link. The website may also provide integrated pdf files which provide quick access to technical information and may be downloaded by bona fide sample applicants and in some cases any person accessing the website (e.g., for general marketing information). By clicking on an HTML link the sample applicant may access further information. If this information is deemed to be of value or deemed to have intrinsic need for security or restriction the sample applicant may in turn be exposed to a “pop-up” window requesting that the sample applicant enter additional information. At this stage the sample applicant is subjected to one or more vettings or security screenings. This vetting may be the first vetting of the process. The first level of security may be present for the purpose of, for example, capturing the sample applicant's identity information, such as e-mail address, which may be archived and used in later marketing efforts. Alternatively the first level of security may be used as a go/no-go criteria to ensure that any sample applicant does not advance further to access technical information or order samples.

It is preferred that only a single level of vetting security exists for purposes of simplifying user access to the technical information library and ordering function. Therefore, if a sample applicant is unable to pass the first security test, the sample applicant may be rejected and the sample applicant may not be provided security access for placement of sample orders or access to technical information.

After a sample applicant has been vetted a “cookie” may be placed in the memory of the client computer from which the sample applicant is accessing the sample ordering process. The cookie may provide, for future sample or information requests, immediate recognition between the client computer and the server computer to allow the sample applicant to immediately, and without further vetting, order additional samples or access a library. In a preferred embodiment, the sample applicant enters a unique pass code. The pass code is compared against pass codes assigned to a particular e-mail address to verify the authenticity of the sample applicant and to provide further access to the process such as sample ordering and accessing technical literature, with as little delay as possible.

Other security and/or screening measures may be included. Any electronically transmitted keys or password/ID threshold may be included to limit access and protect the website know-how from users who are not bona-fide.

A sample applicant wishing to access information or the sample ordering function must input at least an e-mail address and preferably further information such as a physical address, company affiliation, commercial affiliation or community affiliation, and comments. Not only may this information serve to vet the sample applicant it may also provide a means for alerting a local sales representative of a new sales prospect.

In one aspect of the invention process, information regarding a new “sign-in” from a new sample applicant is accumulated and stored, it may then may be given a score and then analyzed and/or assigned to an appropriate sales representative. An appropriate sales representative may be chosen based upon geographical location or upon other factors including the familiarity of the sales representative with a technical area identified as the technical area of interest by the sample applicant. The sales representative or distributor may be alerted in an automated fashion, for example, the process may include the automated mailing of an electronic mail directed to a specific distributor, sales representative or marketing representative for the supplier of the sample material.

This automated procedure for vetting a sample applicant compares the sample applicant's information against an archived database or analyzes the inputted information logically. During vetting the e-mail address of the sample applicant is judged in one respect by determining the source of the e-mail such as the company, organization or employer with which the sample applicant is associated. Determining the source of the e-mail may include an analysis of the complete e-mail address or may include analysis of other identifiers included with the electronic signal that makes up the e-mail message. In one embodiment the sample applicant's information is directly compared with a database of identities which have been pre-vetted and given an approval or denial status for receiving technical information or permitting access to the sample ordering function. For example, a consultant or small company with whom the sample supplier has not previously engaged in business may wish to access the sample supplier's technical information or obtain samples. In this case, the sample applicant may contact the sample supplier directly, through a distributor or through a sales representative in order to obtain the necessary approval status and have the sample applicant's identity information and approval status entered in the database. When the sample applicant requests a sample in the future or wants to access technical information, the sample applicant may enters a password and/or identifier information when accessing the website and may then be provided selective access to either or both of the technical information library or sample ordering function. A sample applicant may be given only partial access. For example the sample applicant may be given access to the technical library but may not be allowed to order samples or alternatively may be allowed to order samples and not be allowed to access the technical library. It is preferred that a sample applicant who has partial access is also given access to the sample ordering. In an especially preferred embodiment of the invention any sample applicant that has been vetted and identified as bona fide is provided full privileges to order samples and order or download technical data. In this especially preferred embodiment the bona fide sample applicant may order any samples and/or download or order any technical information without restriction.

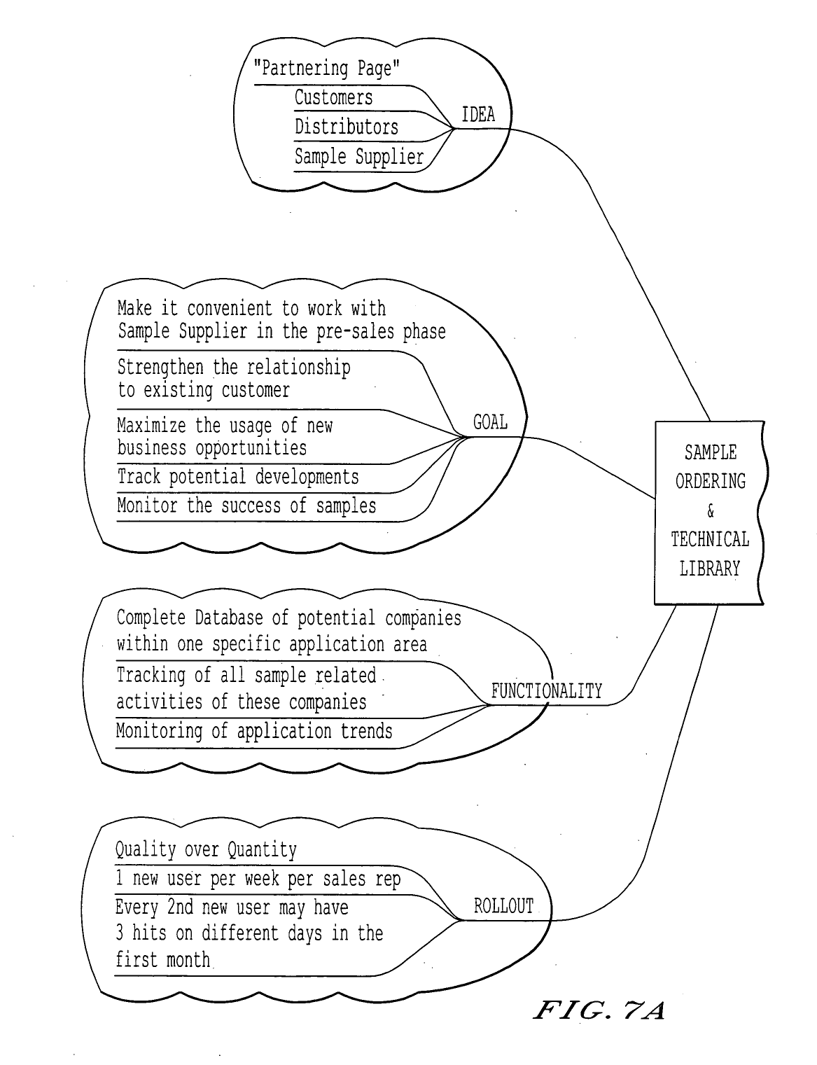

FIG. 6 provides a schematic diagram of how vetting may be carried out. The process begins when a sample applicant accesses the sample supplier's website. A first criterion may include whether or not the sample applicant is a “cookied” sample applicant. If the sample applicant is cookied and the information in the cookie indicates that the sample applicant is a bona fide sample applicant, the process may permit immediate access to the sample ordering and technical library functions of the process. If the sample applicant, on the other hand, is not immediately identified as bona fide through the presence of a cookie on the client which is used to access the process functions over the computer-based network, the sample applicant may be prompted to input certain identifying data. This data may include, an e-mail address, shipping address, or other information which may uniquely identify the sample applicant and the organization or community for whom the sample applicant works or is otherwise associated with. Upon inputting the identifying information, the process may carry out an analysis to determine whether or not the sample applicant is a bona fide applicant. The analysis may include a comparison of the inputted data with a database of bona fide or not bona fide sample applicants. If the sample applicant is immediately identified as not bona fide by comparison, for example, to a database which indicates that the sample applicant belongs to a competitive organization or otherwise has adverse interest to the sample supplier, the sample applicant may immediately receive a denial of access message and may not proceed further to the sample ordering or technical information functions of the process. If no determination can be immediately made that the sample applicant is not a bona fide applicant, the identifying information may be further compared to other databases or may be subjected to a logical analysis (e.g., an analysis of the domain name present in the e-mail address) to determine whether or not the applicant is a bona fide sample applicant. Upon passing this security or screening function, the sample applicant may be identified as bona fide and may be provided with access to the technical data or sample ordering functions. Concurrently, the sample applicant's identifying information may be archived into a sample applicant database for future reference. Further, a sales representative may be notified and given the sample applicant's identify and geographical location for follow up. Through contact between the sales representative and the sample applicant feedback regarding the performance of the sample may be obtained and then circulated to the marketing and research and development groups of the sample supplier for further development and/or marketing work.

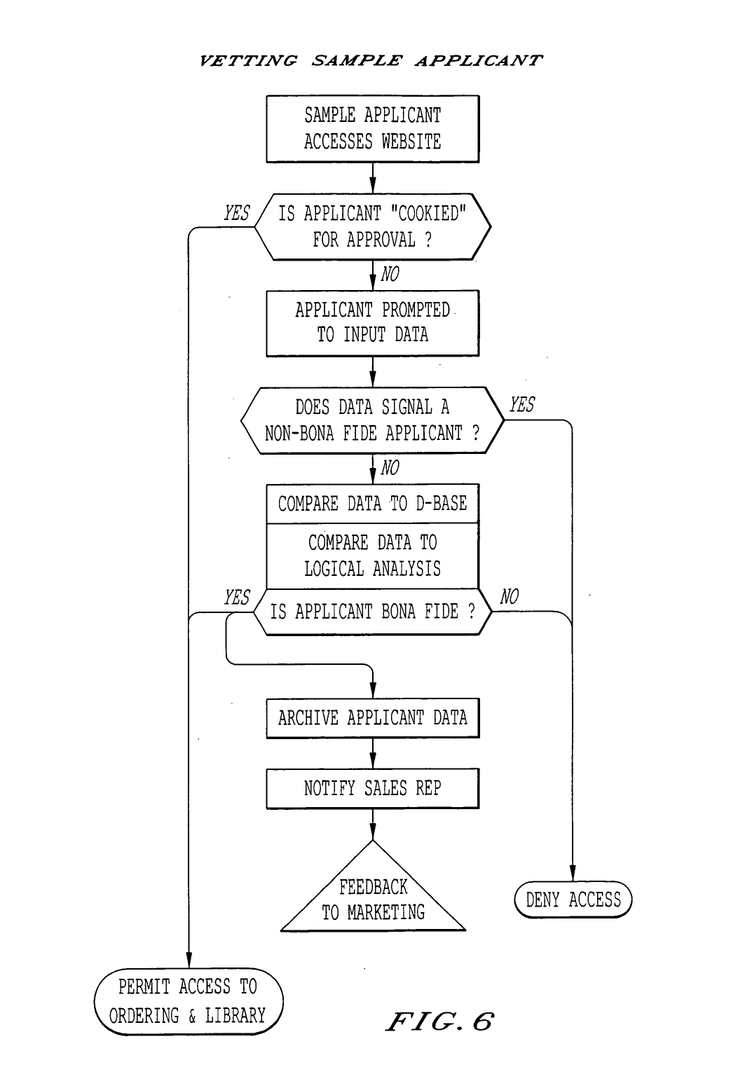

FIG. 5 shows how the sample supplier may follow up on a single sample order or utilize a statistical analysis of sample orders to determine if further product development may be warranted. For example, once a sales representative (for example, in-house sales representative of the sample supplier, agent or distributor) is notified of a sample order, the sales representative may begin by first contacting the sample applicant. The sample applicant may be questioned with regard to the need for the sample. The need for the sample may include whether or not the sample is intended to replace an existing but expired sample or if the sample is intended to be a part of new application trials at the customer's location. The sales representative may collect application information such as the type of end-use the sample is expected to be used in. If the sales representative determines that this application information may be interesting or useful to the sample supplier's marketing organization the sales representative can send the application information to the marketing group. If the sample applicant later places a commercial scale order the sample request can be positively correlated with the application. This information may be especially useful in finding new applications for existing products and does not require the sample supplier to carry out testing and/or experiments but instead allows the sample supplier to observe the reaction of the marketplace with respect to the product and thereby determine if new applications are commercially viable and/or technically feasible. Clusters of samples where several sample applicants are testing a new product for the same application may be identified statistically, for example by trend analysis where the number of sample is plotted against time and any non-linear or otherwise unusual or unexpected ordering patterns may be visually identified or identified through mathematical analysis. Once a cluster has been identified the marketing and product development functions of the sample supplier may develop new products and/or marketing campaigns to address what may have previously been unknown demand or an unknown application or use of an existing product.

In a preferred embodiment of the process a majority, most preferably 100%, of the sample applicants are vetted automatically either by database comparison or logical analysis without intervention from a person or other administrator of the sampling process.

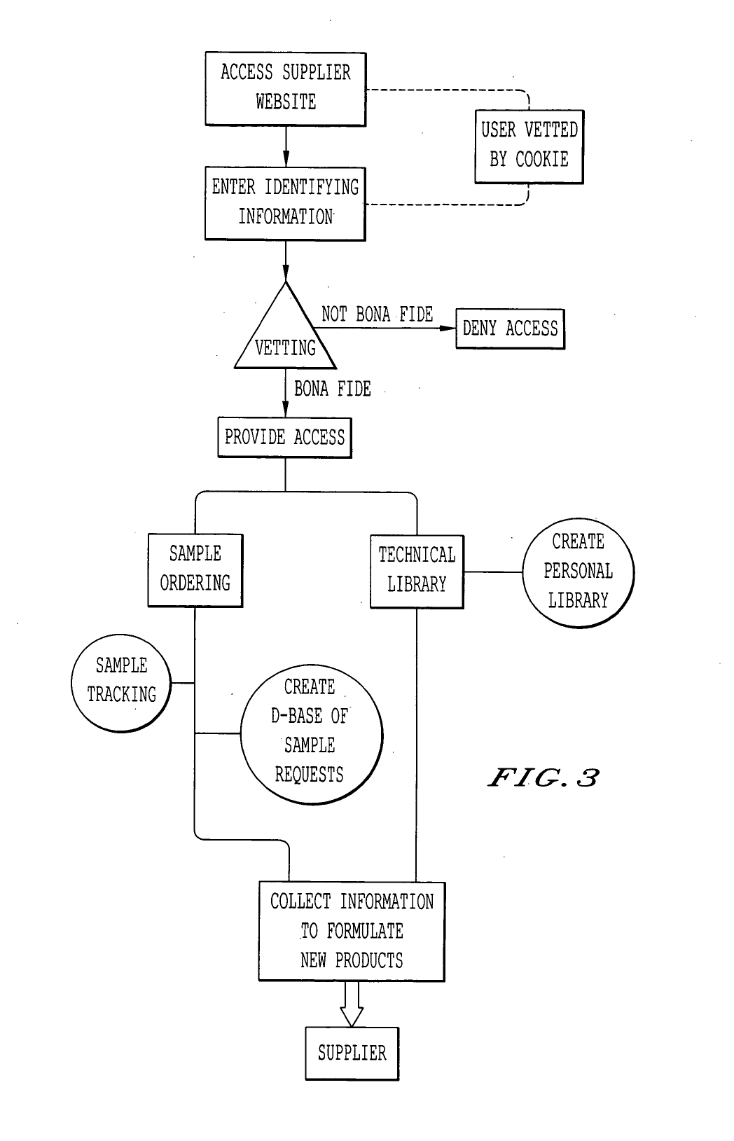

FIG. 3 provides a schematic of the steps which may be involved in ordering a sample and vetting a sample applicant. In FIG. 3 the sample applicant first accesses the supplier website, for example, over the Internet. If the sample applicant has previously accessed the website and a cookie has been placed in the client memory the sample applicant may be automatically forwarded to a vetting function. If the sample applicant has not previously accessed the website, the sample applicant may be prompted to provide security information including, for example, identifying marks such as an electronic mail address, affiliation with community member, or employer name. Vetting may then be carried out. Any sample applicant identified as non-bona fide may be denied access to any or all of the website functionality or information available therein. A sample applicant who is identified as having bona fide intentions that may be commercially beneficial to the sample supplier is then provided access to either the sample ordering or technical library, preferably access to both the sample ordering and the technical library. If the sample applicant orders a sample the sample tracking functionality is initiated so that the sample applicant may be informed of the status of the sample. The information pertaining to the order of the sample is archived in a database. The database may have a secondary structure which forms a personalized sample order database library which may be later accessed by the sample applicant. If the sample applicant wishes only to access additional technical information, the sample applicant may do so by downloading or requesting further information by clicking through HTML links or by downloading pdf files. For each piece of information downloaded by the sample applicant, a record is kept and archived to form a personalized library database of technical information for the sample applicant which may later be accessed. All of the information collected and archived during the sample ordering process is immediately available to those members of the sample supplier who engage in, for example, marketing and research and development efforts.

In addition to the automated approval system an administrator function may be provided. In the administrator function, a sample applicant requesting information or a sample may be placed in an “indeterminate” status which indicates neither approval nor denial to either of the sample ordering function or the technical library. The indeterminate status may notify sample applicants who belong to an organization or a company that has been identified as adverse to the sample supplier that further vetting may be necessary. In some large organizations one division of a competitor may be determined to be adverse to the sample supplier (e.g., other divisions, departments, wholly owned subsidiaries, joint ventures, and marketing partnerships), however since entities or divisions of the same organization may operate on a semiautonomous basis from the remainder of the organization, they may be provided selective access to the sample ordering or technical library functions. In order to be certain that such a sample applicant is indeed bona fide, the sample applicant's request may first be directed to an administrator. The administrator may be an individual in the sample supplier's marketing organization, a sales force representative (in-house or distributor) or other person capable of deciding whether or not the sample applicant is bona fide and whether or not providing approval authority for sample ordering or technical library access is in the best interest of the sample supplier.

When a fully vetted and/or bona fide sample applicant attempts to place an order or access technical information the administrator may be notified, for example, by electronic mail. The electronic mail received by the administrator may be accompanied by a separate message indicating that the request for sample or request for information is time sensitive and provide the administrator with a minimum period for response. The administrator may then take several courses of action including contacting the sample applicant directly, conferring with other members of the sample supplier's organization to determine whether or not provision of the sample or technical information is in the best interest of the supplier, or cross-referencing the sample applicant with a predetermined list of bona fide and not bona fide criteria. In a preferred embodiment, the administrator function is completely automated and carries out vetting without human intervention.

A sample applicant who is refused access to the sample ordering function or access to the technical library may be informed in one of several ways, including, by electronic mail explicitly notifying the sample applicant that access may be first obtained by speaking with a representative of the sample supplier, communication of an explicit denial stating simply that access will not be provided, or other message determined from a library of responses.

As mentioned earlier, any input received from a sample applicant may be brought to the attention of an appropriate sales representative or individual from the sampling supplier's marketing organization. It is preferred that this transfer of information from sample applicant to sales representative occur in an automated fashion over a computer-based network. The input of information from the sample applicant automatically generates a message that is transmitted to the sales representative or marketing organization by electronic mail. Each electronic mail is marked with the date and time of sending and provides a period for response. In a preferred embodiment of the invention, the sample supplier has an integrated enterprise resource planning (ERP) system wherein the automated message places a reminder or an appointment on the sales representative's or marketing organization's business calendar.

In one embodiment of the invention sample applicants who are denied access to the technical database or sample ordering function are accumulated in a database; however, the sample applicant is provided no further follow-up.

Sample applicants who are approved for sample ordering or for access to technical information may be given immediate approval to place sample orders or to access the library. Concomitantly, the sample applicant's approved status and identity is communicated to a sales or marketing representative of the sampling supplier organization. The sales or marketing representative may be notified by electronic mail. The electronic mail may be transmitted over the sample supplier's intranet. The sales representative or any individual within the sample supplier organization may retrieve and access information remotely through the Internet. A traveling sales representative may obtain daily updates of sample requests and technical information requests. The sales representative may be a direct employee of the supplier organization, a contract employee whose compensation is provided through a third party, or an employee or an associate of a distributor that carriers or otherwise represents the sample supplier in a sales capacity. The distributor may be given selective access to the sample supplier's intranet computer system or the distributor may receive e-mail messages containing limited information with regards to new sample requests and updates on sample applicant information. In an embodiment of the invention the distributor is provided access only to the technical library. The distributor therefore is able to provide technical information to new sales prospects; however, the distributor may not be able to directly place orders for samples. In another preferred embodiment the distributor has access to the order function and the technical information function of the process and can independently send samples to bona fide sales prospects.

When a distributor identifies a sales prospect the distributor may separately vet the sales prospect to obtain pre-clearance so that the sales prospect may have immediate access to either or both the sample ordering function or the technical library. In this embodiment of the invention the distributor first obtains approval for the sample applicant by contacting, for example, the administrator of the process at the sample supplier. Once the distributor-identified sample applicant is given approval (e.g., vetted) the information is directly placed in the archived database against which sample applicants may be vetted. Therefore, as soon as the distributor pays a visit or otherwise contacts a new sales prospect the distributor, or sales representative, can immediately demonstrate the sample ordering function and/or the technical library. This embodiment of the invention provides a substantial benefit when initiating new contacts with sales prospects. Since the effectiveness of a contact with a sales prospect is related to the prospect's ability to immediately make use of information provided during the contact, pre-clearance allows immediate use of sample ordering and technical library functions. Further, the use of the website may be demonstrated directly to the sales prospect during the sales presentation or visit by either the distributor or a sales representative of the sample supplier.

The process provides a significant advantage over conventional processes for sampling, providing technical information and follow-up on sales contacts. The invention process allows very short follow-up times to be achieved and imposes a discipline of timed follow-up. The sales force, distributor network or marketing organizations may be monitored for compliance with guidelines with regards to follow-up times and the effectiveness and return on investment for visiting new sales prospects may be determined.

The process offers several advantages to the sample applicant. The sample applicant is able to access information directly relevant to a project, technology or sample type the sample applicant is working with. The sample applicant may be able to access all information that was previously accessed by the sample applicant and therefore does not have to maintain a paper file. The sample applicant may track their own information requests and sample orders to determine the status and date of arrival. The sample applicant may minimize sample orders by using the process and the database provided as a sample inventory system to monitor samples stored at the sample applicant's location and received from the sample supplier.

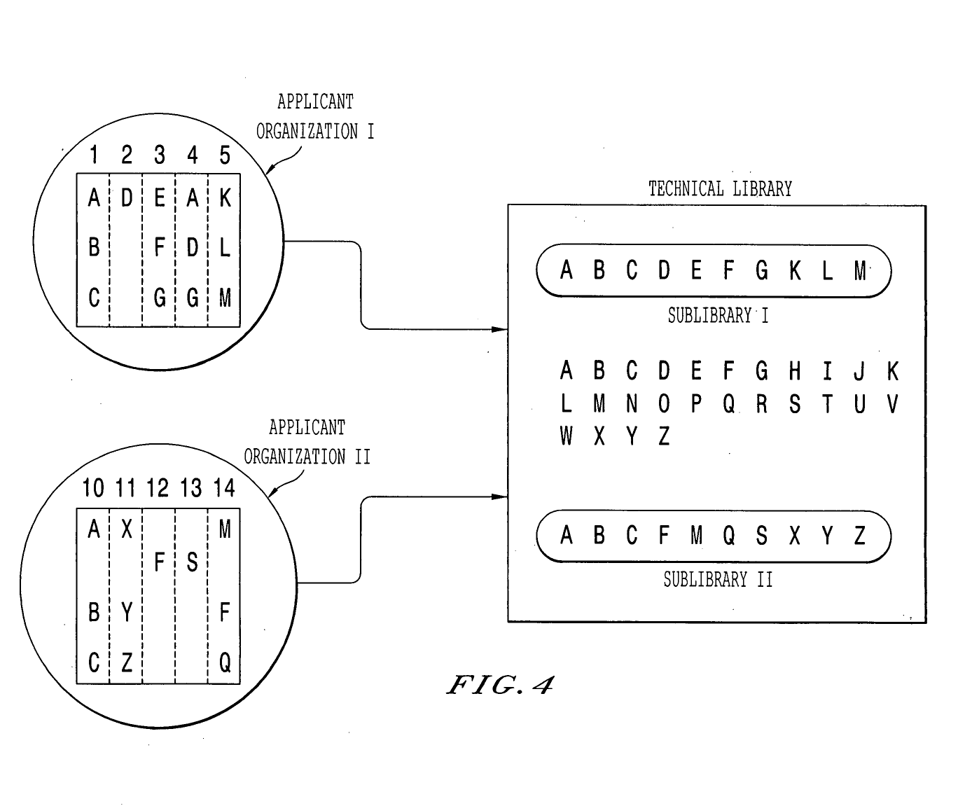

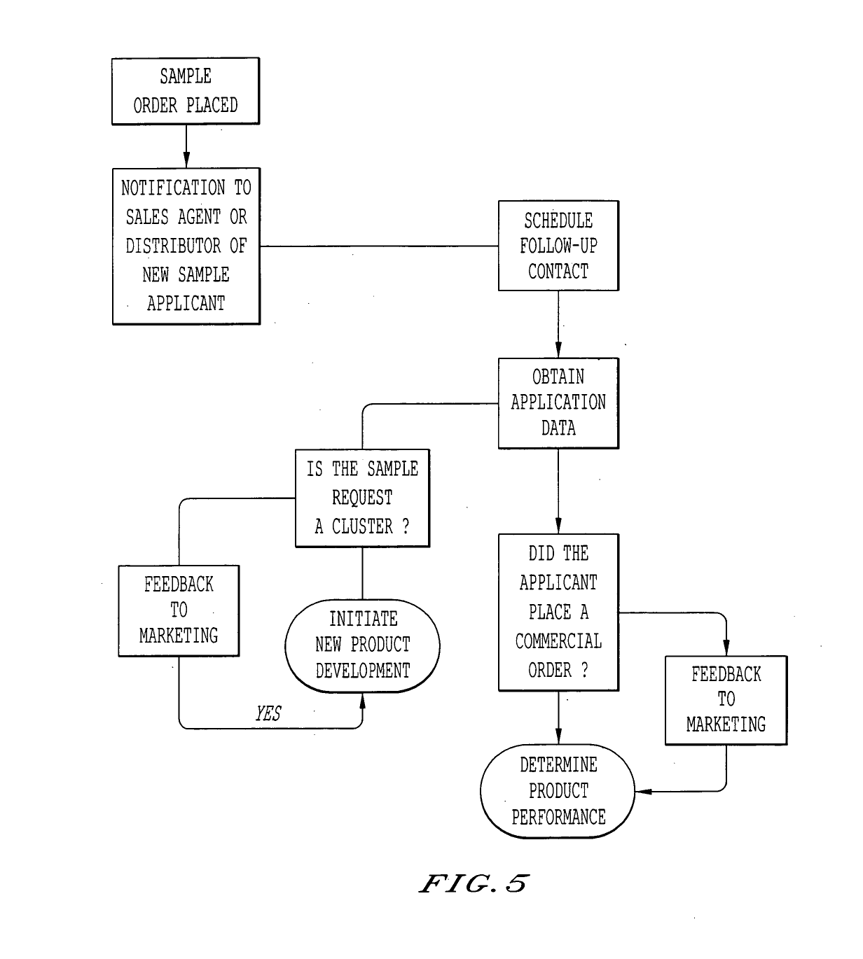

FIG. 4 shows how sample requests by different persons (e.g., sample applicants) within a single organization or community may access certain information in the sample supplier's technical library and thus form a personalized technical library that may be accessed later by anyone in the original sample/information applicant's community or organization. Applicant Organization I has five individuals each of whom has requested certain technical information, each document is represented by a capital letter in FIG. 4. Each of the documents is available on the sample supplier's technical library. After the five individuals in Applicant Organization I have accessed the information (shown tabulated relative to each of individuals 1-5) a sub-library may be formed in the technical library database of the sample supplier. The sub-library may be present on the server or in another memory device accessible to both the sample applicant over a computer-based network or any member of the sample supplier through the Internet, intranet, or, for example, a VPN. The process may also be carried out concurrently for Applicant Organization II. Individuals 10-14 of Applicant Organization II each request certain information identified by the capital letters relative to the individual's identity. This information is then captured and archived and a second sub-library (personalized technical library) may be archived for access by any of individuals 10-14 or any other individual who is vetted as a sample applicant from Applicant Organization II. It is not necessary that each organization have a specific database wherein each of the documents is duplicated. Instead, the database may consist of codes which represent and are keyed to the individual documents or technical information. Thus the archive consists not necessarily of the individual documents which may take substantial memory resources but rather codes which correspond to the document which are located separately in the same or a different server as a database.

The website of the sample supplier may provide basic information exposing the sample applicant to the sample supplier's trademarked or trade dress materials or information. Such information is generally widely available to the public and may have only minor immediate or marketable commercial value to a sample applicant security protocols may be set up so that each time a sample applicant accesses the website, for information or for sample ordering, the sample applicant may be exposed to the trademark and trade dress of the sample supplier. The sample ordering website may provide links to other of the sample suppliers' product lines or other suppliers to the particular industry or application area which is most associated with the particular sample types and/or product lines identified in a particular website.

In one embodiment the process allows the sample applicant to access to a broad range of basic information through an Internet website. This basic information may include the general chemistry and/or physical properties of the materials marketed by the sample supplier. Highly detailed application information may also be made available if the sample applicant is vetted as bona fide and is provided access status.

The ability to quickly and efficiently place an order for a sample on-line may be a substantial benefit for a sample applicant. A sample order may be placed at any time of the day on any day of the year. The sample order may be directly transferred to the sample supplier sample fulfillment center thereby removing any intermediate layer of sales or marketing review. Thus substantial time can be saved for the sample applicant. The savings may provide a significant strategic advantage for the sample supplier by providing the ability to be the first to provide a sample. In many cases the first sample that arrives at a sales prospect is the sample that is used in the experiments or application and eventually approved for the application.

In addition to general technical information or highly specialized technical information that is application specific, any sample order placed through the process may be shipped with a certificate of compliance (COC) or certificate of analysis (COA). The COC and/or COA contain much useful information for the sample applicant. Importantly the specific properties and quality attributes associated with a sample received by the sample applicant can be correlated with the performance of the sample applicant's experiment or project. Further, the sample supplier is able to identify specific properties associated with samples if feedback from the process indicates that those properties are desired and advantageous to sample applicants.

Each sample may be provided with an expiration date printed on the sample label. The sample applicant is therefore able to determine quickly from the information provided on each sample received from the supplier whether or not the sample is within its useful life.

The sample applicant may also retrieve a material safety data sheet (MSDS) from the technical library or receive an MSDS with the sample. The MSDS provides the sample applicant with safety information regarding the sample. In a preferred embodiment of the process an MSDS is shipped with each sample. Upon receipt of a sample by the sample applicant it may occur that the MSDS is separated from the sample. The sample applicant may therefore be provided with access to the MSDS on-line at the sample applicant's convenience.

The sample applicant may also realize advantages relating to the ordering of the sample. Upon entry of an order the process may provide an automated confirmation notifying the sample applicant that an order has been entered. The order may be given a specific order identity from which the sample applicant may track the status of the order. In the process it is preferred that any sample order is filled (e.g., packaged and shipped) within 3 business days. It is preferred that the sample arrives at the sample requestor's location within three business days after entry of the order or receipt of the order at the sample supplier. The immediate status of the order, for example, order accepted, order packaged, order shipped, order in transport, order received at shipping substation, and/or order received at sample applicant's location, may be available when the sample applicant enters the order identity into the sample supplier's website.

The sample tracking and sample status may be facilitated and enriched by incorporating the shipping and logistics information provided by a third party shipper, transporter or provider of logistic support. The third party logistics provider may utilize, for example, a barcode system wherein each package is individually labeled and identified by a unique number. The information may be collected and monitored by the third party logistics supplier and may be accessed separately over the Internet through a website maintained by the third party. This information may also be transferred directly to the sample supplier website so that the information is available directly through the sample supplier's website and access to a third party website is not necessary. In a preferred embodiment of the invention sample tracking information is provided through the sample supplier website and may be accessed by a bona fide sample applicant. Tracking information may include the unique identifier of the package (e.g., as identified with a barcode label), the nature of the sample, for example, hazardous material (e.g., flammable, combustible, toxic, radioactive) and location of the sample (for example, in transit, received at a shipping cross-point). By allowing the sample applicant access to the sample status and tracking information, the sample applicant is better able to plan and carry out experiments.

Any sample order placed by an approved (e.g., bona fide) sample applicant permits the sample applicant to enter specialized information and comments. A field is provided for the applicant to enter information which the sample applicant wishes to appear on the shipping or sample label. The comments or information provided thereon may include such information as return authorization codes and other information identifying that the sample is acceptable to receive at the sample applicant's location. The comments may further include other important identifiers such as hazard class, special handling instructions and the contact information for the direct individual responsible for carrying out experiments or otherwise handling the sample.

In addition to the sample ordering functions, a sample applicant is provided with other substantial benefits from the process. Each time a sample applicant accesses the technical library and requests information either through the mail or by download from the sample supplier's website, a record is made of which information is requested. The information requested and the specific identity of any documents such as technical data sheets, MSDS, certificate of analysis, or other information is then archived. The archive becomes a personalized library for the sample applicant or the sample applicant's organization. In the future, should the sample applicant wish to access information previously downloaded but no longer immediately available in the sample applicant's personal records, the sample applicant may log-in to the personal library and easily identify which information was requested and review it on-line or download it for printing.

The personal information library addresses the difficulties associated with maintaining a large body of technical information provided by a number of different sample suppliers. Technical information may be misplaced or prematurely discarded as not useful. It may later be determined that the information is desirable and its identification at the later date may be difficult. The personalized sample library provides a means of identifying the particular piece of technical information or document that was previously downloaded and may provide any updates or new versions thereof. Importantly, the personalized sample library may be able to identify improved products or improved technical information or other advances made in the field which may be of interest to the sample applicant and which the sample applicant may make use of in order to stay current of cutting edge technology.

The process provides significant advantages to a sample supplier and to a sample supplier's sales and distribution network. All samples may be tracked and monitored for appropriate follow-up by sales representatives or distributors. Follow-up may be automated so that any sample or information request automatically generates a report to an assigned responsible sales representative or a management representative. Automated follow-up may include distribution of an electronic message to a sales representative, distributor or a member of the sample supplier's marketing organization on a timed basis. The follow-up message may also be based upon other criteria such as the number of samples in the sample representative's sample pool or other information inputted into the system such as subsequent follow-up visits made to the sample applicant by the sales representative.

Each sample may be associated with a particular sample supplier sales representative, distributor sales representative or marketing agent. The samples associated for particular individuals may form a sample pool and may also be organized by any particular individual, organization or division. The sample pool may be accessed electronically by only the sales representative, distributor etc. or more preferably it may be monitored by any member of the sample supplier organization.

A sample identified by its unique number and sample applicant is entered into the sample pool after the sample order has been placed or at any other time determined as effective by the administrator of the process. The sample may alternatively be updated in the sample pool upon receipt of the sample, shipping of the sample or upon further inquiry by the sample applicant.

The personalized sample pool is accessed by each individual sales representative through the sample supplier's intranet or internet. The information may be accessed remotely through the Internet while the sales representative is away from a home base. Typically, a sales representative logs onto the intranet site and downloads an update of all sample pool information. The sample pool information may be provided in one of many common formats including word processing programs such as Microsoft Word or spreadsheet programs such as Microsoft Excel. The information downloaded by the sales representative includes the information necessary to establish direct contact with the sample applicant.

Upon completing the follow-up with the sample applicant, the sales representative may enter additional information into the sample supplier archive. This additional information may include a description of the experiments or new projects, being undertaken by the sample applicant, an update on the progress of the project or experiment, and, most preferably, comments regarding the suitability of any sample provided earlier and the sample applicant's impressions of the performance properties of the sample. The information thus received may be entered and made available through an applicant information pool. The applicant information pool may be accessed by the sales representative and may also be accessed by other members of the sample supplier's research and development, marketing, and sales divisions. The information is protected from access by other users. The information is not accessible to the sample applicant. The same applicant may access a sample inventory of requested samples.

The status of the samples is also indicated by whether or not the sample is, for example, for general interest, intended for a specific project, or for replacement of an existing sample which has expired and for which a replacement is now needed. The follow-up protocol for the status of the sample may vary depending on the status entered by the sales representative. For a general interest sample a sales representative may make inquiries based on a certain time line to determine if the status of the project or sample has changed or to determine if further information or further samples may be desired by the sample applicant. For general interest samples the sales representative may receive an updated message on a monthly, quarterly, semi-annual or annual basis to determine the level of interest. If the sales representative determines that there are no ongoing projects and there is no immediate interest in further information or carrying out experiments with the sample, the sales representative may indicate this status in a field associated with the sample information and thereby halt the automated transmission of messages regarding the sample.

The status may change if in the future the sample applicant determines that further interest is warranted, a replacement sample is needed or that other technical information or follow-up is justified.

When a sample has past its useful life, as indicated by the expiration date included on the sample label and archived with information regarding the sample identity, an automated message may be provided to the sample representative or other individual responsible for the sales contact. The sales representative may determine that a new sample is necessary or, the sales representative may determine that it is appropriate to change the status of the sample applicant to a non-bona fide status.

Samples that have been identified for immediate use within a sample applicant's organization for a specific project or a particular experiment may be given a high priority project interest identifier in the sample pool. Those samples identified for use in a project may be among the most valuable to the sample supplier because the samples may be used directly and evaluated against competitive materials.

The sales representative may identify specific information with regards to the project if such information is made available to the sample supplier. The specific project interest and application is preferred information. This information may be included in the sample archive which may be accessed later or on an “on demand” basis at any time by, for example, the research and development and marketing divisions of the sample supplier. Any sample which is identified for use in a project or experiment at the sample applicant's location may be given high priority and may receive faster follow-up than samples identified as only general interest or samples where the expiration date has past. Preferably the sales representative collects information with regards to the project application such as the end use (e.g., commercial embodiment) in which the experiment or project will eventually take form, information regarding the quality and performance attributes needed in the sample in order to successfully be commercialized.

Other information such as whether or not the sample applicant is replacing an existing competitive product with the sample supplier's product or whether there is a specific drawback or detriment associated with competitive products may be included if this information is made available by the sample applicant.

In another aspect of the invention a sample applicant may be guided through sample selection by referring to product information available on the website. For example, a sample applicant may be first asked what the end-use application includes. Such end-use applications may include for example coatings, fillers for composites, and colorants. Upon selecting the application the sample applicant is directed to a next level of questioning which may include the performance attributes desired in the finished product. Performance attributes may include, for example, gloss, whiteness, and flattening. The sample applicant may be asked a series of additional questions on different levels comparing, for example, products already trialed. The answers which the sample applicant inputs in response to the questions are directed to a decision tree which logically determines which sample type may be of greatest interest or may provide the greatest opportunity for success in the sample applicant's application. Therefore, the process provides not only a method of placing an order for a sample but may also provide a method for identifying the appropriate material to sample.

In another aspect of the invention, a sampling regimen may be pre-programmed in cases where a sample applicant has identified a need to receive samples on a regular basis. For example, when the expiration date of a sample is reached the customer can be notified in an automated manner. The notification may also be arranged on any occurrence based on date or other interaction with the sample applicant. In this aspect of the invention, an email may be automatically generated and sent directly to the sample applicant or a distributor or sales representative responsible for the sales applicant's orders. The email message asks for confirmation that a sample is indeed required. After confirmation, either from the sales applicant or from the sales representative or distributor, or both, the order is then automatically placed in the order fulfillment center of the sample supplier. The automated sample ordering system may use, as a trigger for beginning a new sample ordering routine, time (e.g., number of days, weeks, months, years, etc.) or the expiration or nearing expiration date of the sample already present at the sample applicant.

New applications may be identified by examining trends in sample orders and through feedback obtained from bona fide sample applicants. Upon identifying a new application for an existing product, or upon otherwise receiving notice with regards to any application, a global electronic mail may be transmitted informing bona fide sample applicants of the new application or relevant information. In this manner the process may act as a means to maintain a marketing database.

Sample shipping and sample preparation may be undertaken in different ways. The sample may be taken from an inventory of pre-packaged samples and provided with a label including information regarding the identity of the sample applicant and any comments or return authorization information the sample applicant has requested to be placed on the sample and/or the sample shipping box. The sample may be forwarded to a sales representative who is an employee or contractor of the sample supplier for direct and personal delivery to the sample applicant. It is preferred that the sample is shipped to the sample applicant by a third party logistic supplier that may be integrated into the sample ordering system. It is further preferred that the third party or logistic supplier has a tracking system which allows real time updates of the sample delivery status. In an especially preferred embodiment of the process, the third party shipper or logistic supplier directly downloads information regarding the sample's shipping status into the sample supplier's enterprise research planning (ERP) and/or shipping/logistics data management system. Upon pick-up of a package for delivery to a sample applicant, the third party's tracking software updates the sample status in both the sample supplier's database and the database of the logistics supplier. In one embodiment of the invention each time the sample status changes due to an action on the part of the logistics supplier, for example, a sample pick-up, receipt at a shipping destination or substation, or delivery to the sample applicants' receiving warehouse, an automated email may be sent to the sample applicant to provide updated sample tracking information.

As a sample request is received by the sample supplier after entry of a sample order by a vetted and bona fide sample applicant, the sample order may be forwarded to an order fulfillment area. In the order fulfillment area a sample is packaged in an appropriate package (e.g., for hazardous or non-hazardous shipping) and a label is applied. The label may contain information including expiration date, lot number, any information requested by the sample applicant to be placed on the sample or on the shipping container, a unique order identity associated with each sample order and the shipping address. The label, sample and any necessary shipping documents or safety documents such as an MSDS may be included and the label is provided on the package surface.

The sample supplier may maintain a ready inventory of packaged samples which require only that an updated label providing the information requested by the sample applicant and the unique order identity be applied before shopping.

It is also desirable to have a system to track and evaluate the sample ordering performance and the way in which sales representatives take advantage of the sample ordering process as a part of their sales efforts.

In a preferred embodiment all sample orders are entered and executed through the process. Thereby each sample order may be tracked with its electronic/database history and must therefore be assigned to a sales representative or distributor for follow-up.

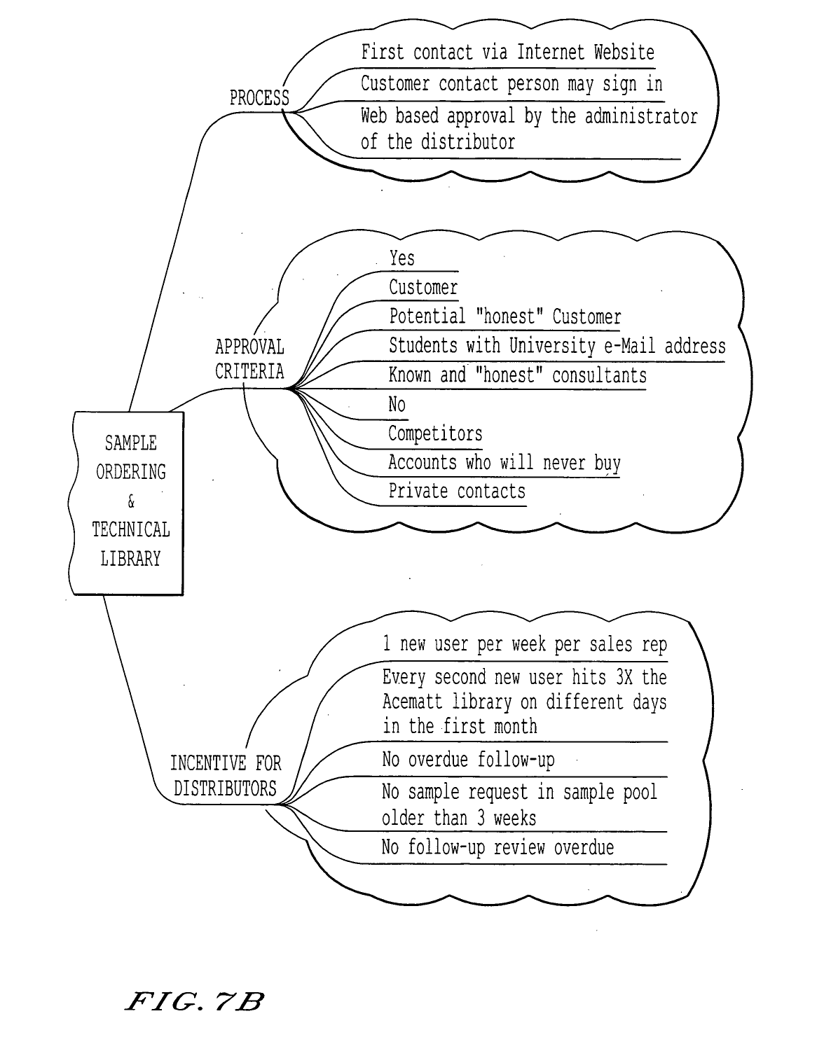

FIG. 7 provides an overview of the interconnections of the functions of the process and the functions that are apparent to the sample applicant. The process may involve one or more of the business units of a sample supplier by coordinating customer data in a manner that provides real time data and analysis of ordering patterns while concurrently providing the customer or new sales prospect with a valuable service by maintaining records information records and application data that may be accessed conveniently later and maintained confidential. The technical database library may act to anchor a process which benefits both the sample applicant and sample supplier by The process permits collection of information about the application and the use of the product; and the selection of the right product and thereby permits a sample applicant to order the product while the sample supplier provides the sample quickly and efficiently; while tracking the shipping and delivering information and providing online information about the sample like CoA, MSDS, expiration date or sample inventory at the customer.

The sales organization benefits by following up by sales or technical questions, tracking the sample to follow up by identifying the use of the sample and providing additional information to enhance communication with the customer and thereby streamline product development work at the customer who can realize time to market advantages.

The process further includes monitoring of the performance of the sales and technical organization based on for example the performance of the product within new product development work, the success of the sample measured by how much new business was developed and there from identify technical and marketing trends which may be forwarded to other parts of the sample supplier organization for product development and marketing activities.

The hardware system and electronic infrastructure used to carry out the process may include at least a server capable of storing, for example, a technical library, customer lists, and having an updatable database for sample tracking purposes. Although only a single server may be used it is preferred that different servers are included and networked. Different servers may be used for different tasks and for storing or archiving different databases having different purposes for the invention process. For example the customer list may be held on a first server, the technical library on a second server, etc. The server may have a memory which may include, for example, a hard drive, and optical storage device, magnetic tape or any other data storage device utilizing any data storage medium accessible by the server.

The servers are internetworked with any number of client workstations. The client workstation may be, for example, a desktop computer, a mobile laptop computer, a mobile phone, or any other device capable of accessing the Internet and therethrough accessing the information provided on the servers and the information in the databases stored therein.

The website through which sample applicants may access the sample ordering and technical library functions may be constructed with software packages having Internet shop or ecommerce suites. The functionalities may be built around a Java application environment using a STRUTS framework as published by the Apache Jakarta project.

Known ERP (enterprise resource planning) software systems including SAP and Novell may interface with the process. The software system may also include in-house developed systems which communicate over the Internet using, for example, TCP-IP. The database may be a relational database or other database which allows association between different aspects of a certain data record such as customer name, samples ordered, and associated sales representative.

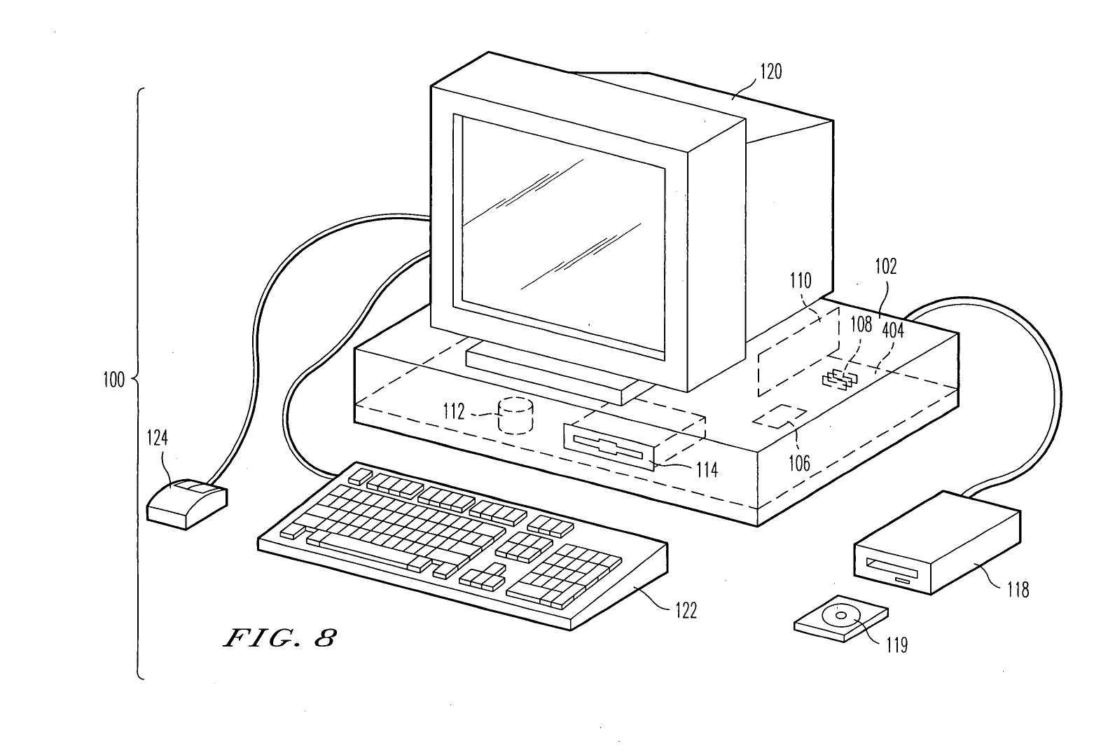

FIG. 8 is a schematic illustration of a computer system which may be used to carry out at least a portion of the invention. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of sample order requests, technical information downloads, compilation of sample applicants and bona fide registrants.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Together, the computer readable media and the software thereon form a computer program product of the present invention for a sample ordering and coordinating process. The computer code devices of the present invention can be any interpreted or executable code mechanism, including but not limited to scripts, interpreters, dynamic link libraries, Java classes, and complete executable programs.

Obviously, numerous modifications and variations of the present invention are possible in light of the above teachings. It is therefore to be understood that within the scope of the appended claims, the invention may be practiced otherwise than as specifically described herein.

1. An automated process for coordinating sample requests comprising:
receiving a sample order inquiry from a sample applicant over a computer-based network connected to a sample supplier;
vetting the sample applicant and assigning a bona fide or not bona fide status to the sample applicant;
permitting a sample applicant having a bona fide status concurrent access to a sample order function and a technical database;
accepting a sample order for a sample responsive to the sample order inquiry from the bona fide sample applicant; and
generating a message to initiate direct contact with the bona fide sample applicant,
wherein during the process the sample inquiry and any technical information requests are archived in an electronic sample database and an electronic technical information database accessible to the bona fide sample applicant.

2. The process of claim 1, wherein the computer-based network is the Internet.

3. The process of claim 1, further comprising:
providing access to the sample order function and technical database to one or more sample applicant communities, wherein each sample applicant community comprises a plurality of individual sample applicants identified by an identifier that is vetted as bona fide.

4. The process of claim 1, further comprising:
storing the sample applicant's information requests in an information request database.

5. The process of claim 4, wherein the sample applicant is a member of an community and the information request database contains all information requests from each sample applicant in the community.

6. The process as claimed in claim 1, wherein the sample applicant is vetted by at least one of comparison with a database or by logical analysis of the sample applicant.

7. The process of claim 1, further comprising:
shipping the a sample to the sample applicant and tracking the location and shipping status of the sample during shipping.

8. The process of claim 1, further comprising:
archiving the sample applicant order inquiry information into a order archive database.

9. The process of claim 1, further comprising:
adding the vetted sample applicant information to a bona fide applicant database.

10. The process of claim 1, wherein the sample applicant information includes at least an electronic mail address.

11. The process of claim 1, wherein the sample is shipped to the sample applicant within three days of acceptance of the sample order.

12. The process of claim 1, wherein the technical database comprises a database of sample information describing the sample.

13. The process of claim 12, wherein the sample information is at least one of a certificate of analysis, material safety data sheet, or the expiration date of the sample.

14. The process of claim 1, further comprising maintaining a database of the samples shipped to the sample applicant.

15. The process of claim 1, further comprising forming a sample request database and a technical information database comprising the sample order inquiries and information requests from the sample applicant and restricting access to the sample request database to allow access to only sample applicants from the community of the sample applicant and the sample supplier.

16. The process of claim 1, further comprising
determining one or more sample order inquiry trends from a plurality of sample order inquiries, and
developing new products responsive to the trends.
